(19) United States
(12) Patent Application Publication
(10) Pub. No.: US 2003/0074329 A1
(43) Pub. Date: Apr. 17, 2003

(54) Computer-implemented method and system for supporting price negotiations

(76) Inventors: Bruno Jandasek, Temperance, MI (US); Dan Wylie, Saline, MI (US); Frederick Miller, Waterford, MI (US); Joseph Sabato, Holly, MI (US); Michael Burns, Lake Orion, MI (US)

Correspondence Address: BROOKS & KUSHMAN P.C./FGTI, 1000 TOWN CENTER, 22ND FLOOR, SOUTHFIELD, MI, 48075, US

(21) Appl. No.: 09/682,701

(22) Filed: Oct. 8, 2001

(51) Int. Cl. G06F 17/60

(52) U.S. Cl. 705/80

(57) ABSTRACT

A method and computer system for generating detailed cost estimates and leveraging suppliers therewith during price negotiations. Computer software reaches input defining items to add to a cost estimate. Automatically, detailed burden information is provided for each item. Additionally, a supply chain including pictures is provided for each item by the item's constituent components and corresponding supplier tier. Detailed burden information is provided for each constituent component. Estimates are output in a format similar to supplier estimates/quotes to facilitate comparison during negotiation. A negotiation method is provided in which suppliers are leveraged with the detailed cost burden and value chain information during price negotiations with the computer software provided.

### BACKGROUND OF INVENTION

1. Field of the Invention

The present invention relates generally to computer-implemented, cost-estimating applications and, more particularly, to a computer-implemented method and system for supporting price negotiations.

2. Background Art

A method and system is needed which places corporate buyers at a greater advantage during pricing negotiations with their industrial suppliers. Many of the industrial products and assemblies that corporate buyers purchase involve a wide variety of components and subassemblies that the buyer may not be completely familiar with. The suppliers, however, generally have greater experience with and a more comprehensive understanding of the various technologies and components their products employ. In addition, buyers are often unable to determine whether their suppliers are implementing the most cost-effective or best-in-class (BIC) manufacturing processes. Due to the overall complexity of most industrial technology, buyers at their respective negotiating tables may not have access to a comprehensive benchmark of manufacturing processes and cost information for the products they are purchasing. Having such information readily available to buyers, however, would provide them with the ability to more effectively challenge the efficiency of their suppliers' manufacturing processes. In addition, buyers may more effectively leverage their suppliers to adopt the most cost-effective or BIC processes to reduce the overall cost of the end product.

Another difficult aspect of industrial pricing negotiations involves establishing accurate design costs for the products being purchased. Conventionally, design costs are calculated as a percentage of overall manufacturing costs. With the increase in the complexity, versatility and cost of computer-assisted engineering (CAE) applications, however, the percentage-based markup for setting design costs has become a less reliable methodology. Similar to design costs, costs for control systems integral to overall systems being purchased are also generally estimated based on a percentage of the total manufacturing costs involved (or, in some instances, a general product description).

Yet another common difficulty with pricing negotiations for industrial products and systems involves the lack of physical similarity between the format of supplier and buyer cost estimates. Despite the fact that the actual content of a buyer's cost estimate and a supplier's cost estimate may be the same, having the content presented in formats unique to one another hampers each negotiator's ability to read and understand the other's estimate. Realistically, however, buyers often negotiate with a variety of suppliers who each have a unique costing format.

Accordingly, a costing tool is desired which effectively overcomes these and other difficulties associated with conventional industrial pricing negotiation practices.

### SUMMARY OF INVENTION

One object of the present invention is to provide a system and method for generating a buyer's cost estimate wherein the buyer is able to “drill down” into the supply chain for a particular estimate to view descriptive and pricing information associated with subassemblies and individual components which compose the overall product or system that is the subject of the estimate. This object is advantageous during pricing negotiations because it allows a negotiator/user to easily break down estimate-level costing information into its constituent components by supply chain. Having this ability provides the negotiator with comprehensive information regarding the product or system supply chain and thereby facilitates the identification and explanation of cost discrepancies between the supplier's quote and the buyer's estimate during pricing negotiations.

Another object of the present invention is to provide a system and method for generating a buyer's cost estimate wherein the estimate includes a detailed estimate of design costs, control costs and labor structure.

Yet another object of the present invention is to provide a system and method for generating a buyer's cost estimate wherein the estimate is output in a format similar to a particular supplier's quote. This object is advantageous because it facilitates the comparison of the supplier's quote and the buyer's estimate to identify cost discrepancies during pricing negotiations.

Another object of the present invention is to provide a database of cost burdens (i.e., component, material, labor, design, overhead costs, etc.) for populating the cost estimate wherein the cost information maintained in the database is globally updated based on a relevant pricing index to reflect fluctuations in market prices. This object of the present invention is advantageous because it eliminates the need to independently adjust each price maintained in the cost database. Instead, a subset of prices representative of the entire cost database is periodically updated to yield an index value which, in turn, is applied globally to adjust the remainder of the pricing information maintained in the cost database.

Yet another object of the present invention is to provide a methodology for conducting buyer-seller pricing negotiations which is supported by the cost-estimating aspects of the present invention. This object is advantageous because during pricing negotiations, negotiators may easily access and compute a plurality of cost information and view descriptive system, subsystem and component information helpful in validating and/or leveraging supplier quotes.

To meet these objects, features and advantages, as well as additional objects, features and advantages of the present invention, a computer-implemented method for generating cost estimates includes defining a cost estimate for a product wherein the product comprises at least one component, and outputting a value chain for the product by component and supplier tier wherein the value chain includes a picture and pricing information for the at least one component.

The above objects, features and advantages of the present invention, as well as additional objects, features and advantages will be readily apparent from the following detailed description of the preferred embodiments when taken in connection with the accompanying drawings.

### BRIEF DESCRIPTION OF DRAWINGS

FIG. 1 is an example graphical user interface (GUI) for generating a manufacturing program cost estimate in accord with the present invention;

FIGS. 2a and 2b, in combination, make up an example GUI for selecting and defining a tool or tool assembly to add to the current cost estimate in accord with the present invention;

FIG. 3 is an example GUI for viewing a detailed supply chain for a particular tool item or assembly, by supplier tier, in accord with the present invention;

FIG. 4 is an example GUI containing a detailed description of a tool item component in accord with the present invention;

FIG. 5 is an example GUI containing a nested supply chain in accord with the present invention;

FIGS. 6a and 6b, in combination, make up an example GUI containing a dependency tree for tool or tool assembly component in accord with the present invention;

FIG. 7 is an example GUI illustrating a design estimate for a tool or tool assembly cost estimate generated in accord with the present invention;

FIG. 8 is an example GUI for defining a labor rate structure in accord with the present invention;

FIGS. 9a and 9b illustrate two cost estimates having identical content generated in accord with the present invention for two different suppliers each having unique cost estimate format requirements;

FIG. 10 is a block flow diagram illustrating a preferred system for implementing the present invention; and

FIG. 11 is a block flow diagram illustrating a preferred method for implementing the present invention.

### DETAILED DESCRIPTION

The preferred embodiments provided in accord with the present invention are generally illustrated and described in the context of the manufacturing machinery industry. The application of the preferred embodiments in this context, however, is for illustrative purposes only and is not intended to limit the scope of contexts in which the present invention may be applied. Notably, the present invention may be applied to a wide variety of cost-estimating and cost-negotiating contexts.

User Interfaces

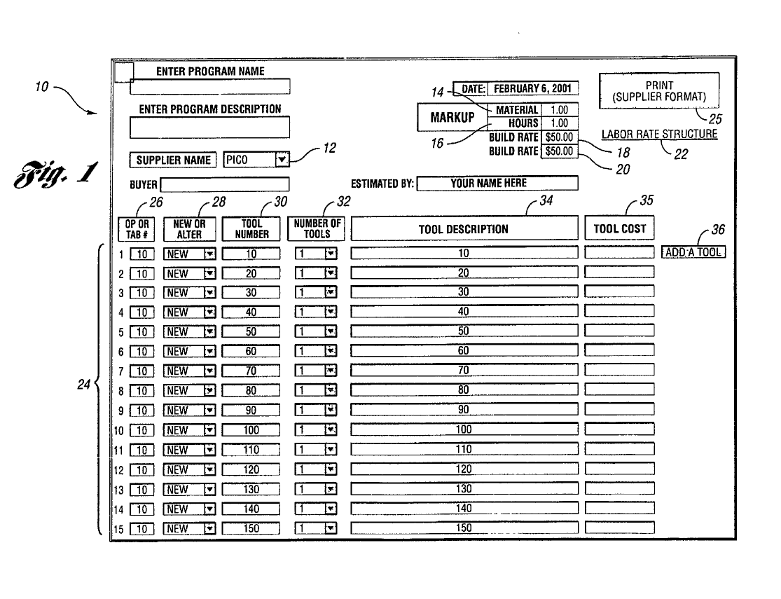

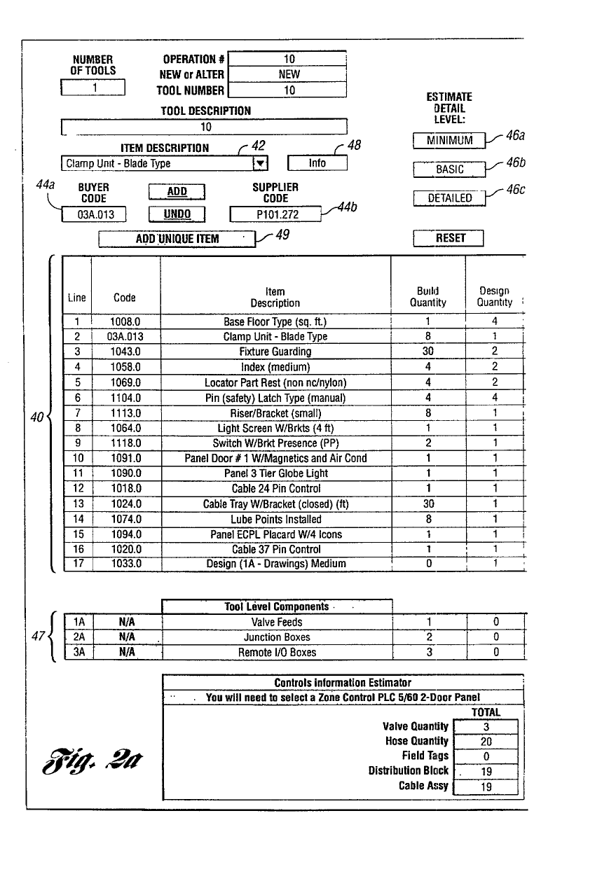

Referring now to FIG. 1, a graphical user interface (GUI) 10 for generating a manufacturing program cost estimate in accord with the present invention is shown. GUI 10 comprises a plurality of data input/selection fields for describing and defining various aspects of the current cost estimate. Data selection field 12 receives user input selecting the name of the supplier for whom the current cost estimate is generated. Data input fields 14 and 16 receive user input specifying a global markup ratio for materials and labor, respectively, that are included within the current cost estimate. Data input fields 18 and 20 receive user input globally specifying a design rate and build (i.e., manufacture) rate, respectively, for components included within the current cost estimate.

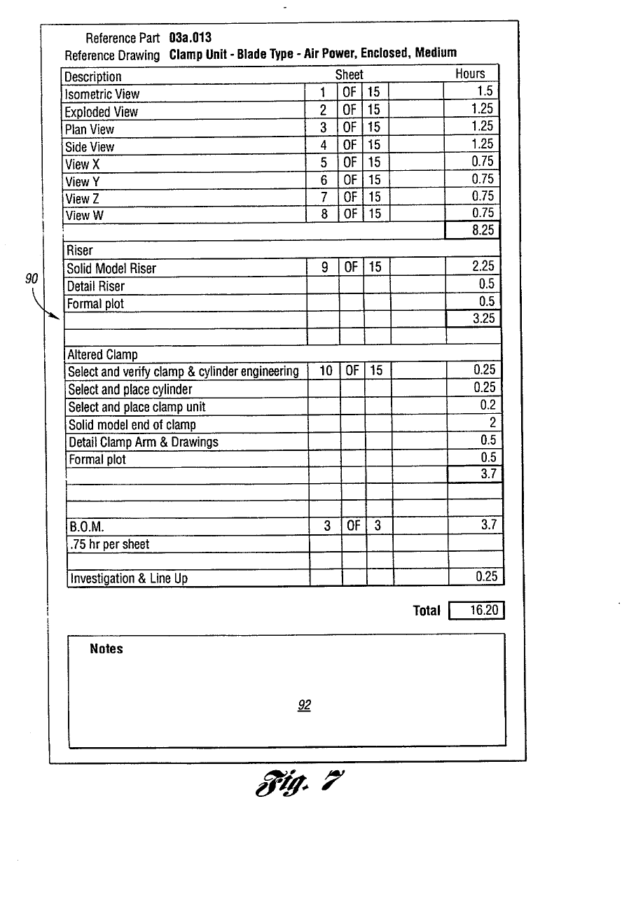

A hyperlink 22 forwards a user to an interactive table for defining a labor rate structure in accord with the present invention. A detailed illustration and description of the labor rate structure is provided below with respect to FIG. 7.

Cost estimate 10 additionally comprises an itemized listing 24 of each manufacturing or assembly tool included with the overall estimate. To add a tool or tool assembly to the current cost estimate, the user inputs, as necessary, an operation number 26 for the tool, an indication 28 as to whether the tool is new or an alteration of an existing tool, the tool number 30, the required quantity 32 for the tool and a tool description 34.

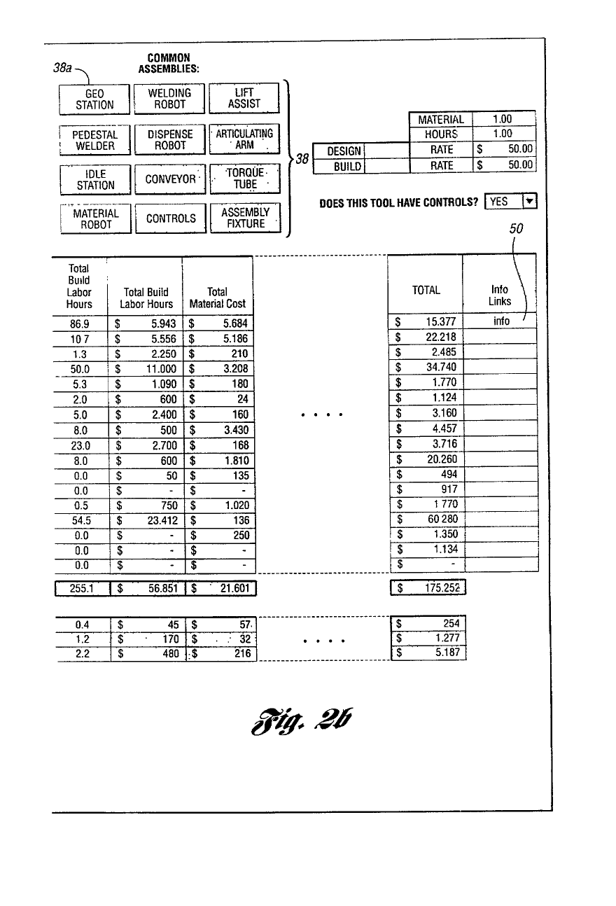

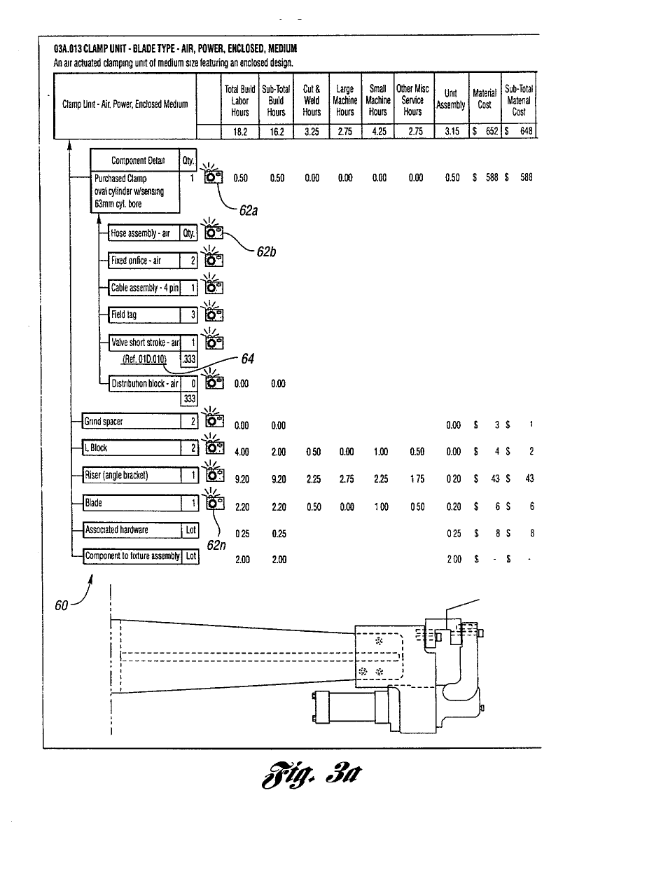

Next, the user selects the “Add a Tool” button 36 and is presented with the GUI illustrated in FIGS. 2a and 2b. FIGS. 2a and 2b, in combination, illustrate a GUI for selecting and defining a tool or tool assembly to add to the current cost estimate 10 illustrated in FIG. 1. Notably, the user may define a tool item by item or select from a variety of predefined tool assemblies 38. Upon selecting a particular tool assembly 38a (i.e., geo station), the software automatically inputs each predefined line item associated with the selected assembly into the tool item cost estimate table 40.

To add individual items to the tool item estimate table 40, the user selects the description of the desired item (i.e., Clamp Unit-Blade Type) from the tool item drop-down menu 42. Preferably, data fields 44a and 44b, respectively, output the buyer and supplier item codes for the selected tool item.

For each tool item listed in the tool item estimate table 40, a variety of tool item information is displayed. In accord with a preferred embodiment of the present invention, the user depresses “Minimum”, “Basic” or “Detailed” estimate detail level buttons 46a, 56b and 46c, respectively, to toggle between the level of estimate detail presented for each tool item listed in the tool item estimate table 40. Table 1 contains a nonexclusive listing, by corresponding level of detail, of tool item information provided in the tool item estimate table 40 in accord with a preferred embodiment of the present invention.

TABLE 1

| Information | Minimum | Basic | Detailed |
|---|---|---|---|
| Line | X | X | X |
| Code | X | X | X |
| Item Description | X | X | X |
| Build Quantity | X | X | X |
| Design Quantity | X | X | X |
| Total Build Labor Hours | X | X | X |
| Cut & Weld Hours | | | X |
| Large Machine Hours | | | X |
| Small Machine Hours | | | X |
| Other Misc. Service Hours | | | X |
| Assy. Hours | | X | X |
| Build Labor Cost | | X | X |
| Build Material Cost | | X | X |
| Purchased Material Cost | | | X |
| Raw Material Cost | | | X |
| Piping Labor Hours | | | X |
| Piping Labor Cost | | | X |
| Piping Material | | | X |
| Wiring Labor Hours | | | X |
| Wiring Labor Cost | | | X |
| Wiring Material | | | X |
| Tryout & Integration | | | X |
| Mechanical Design Hours | | | X |
| Mechanical Design Cost | | | X |
| Controls Design Hours | | | X |
| Controls Design Cost | | X | X |
| Diagnostic Hours | | | X |
| Pipe And Wire Design Hours | | | X |
| Hardware Design Hours | | | X |
| Logic Design Hours | | | X |
| Subtotal Build Labor Hours | | | X |
| Subtotal Build Cost | | | X |
| Subtotal Material Cost | | | X |
| Subtotal Piping & Wiring Labor Hours | | | X |
| Subtotal Piping & Wiring Labor Cost | | | X |
| Subtotal Piping & Wiring Material | | | X |
| Cost | | | |
| Subtotal Mechanical Design Hours | | | X |
| Subtotal Mechanical Design Cost | | | X |
| Subtotal Controls Design Hours | | | X |
| Subtotal Controls Design Cost | | | X |
| Total Build Labor Cost | X | X | X |
| Total Material Cost | X | X | X |
| Total Piping & Wiring Labor Hours | X | X | X |
| Total Piping & Wiring Labor Cost | X | X | X |
| Total Piping & Wiring Material Cost | X | X | X |
| Total Mechanical Design Hours | X | X | X |
| Total Mechanical Design Cost | X | X | X |
| Total Controls Design Hours | X | X | X |
| Total Controls Design Cost | X | X | X |
| TOTAL | X | X | X |

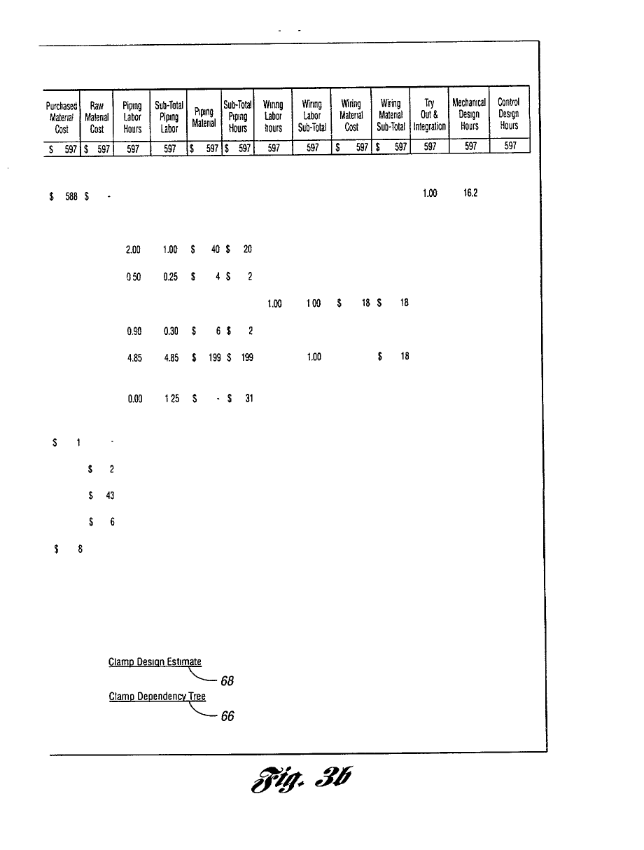

To view a supply chain for a particular tool item, the user may either select the tool item in drop-down menu 42 and depress the “Info” button 48 or select the Info hyperlink 50 associated with a tool item already added to the tool item estimate table 40. In either case, the user is presented with the GUI illustrated in FIG. 3.

Notably, the tool item supply chain 60 shown in FIG. 3 is presented in an outline format to reflect the tiered nature of the item's supply chain. In addition, a detailed description/photograph button 62a for the tool item and each of its constituent components (62b-62n) and subassemblies is provided.

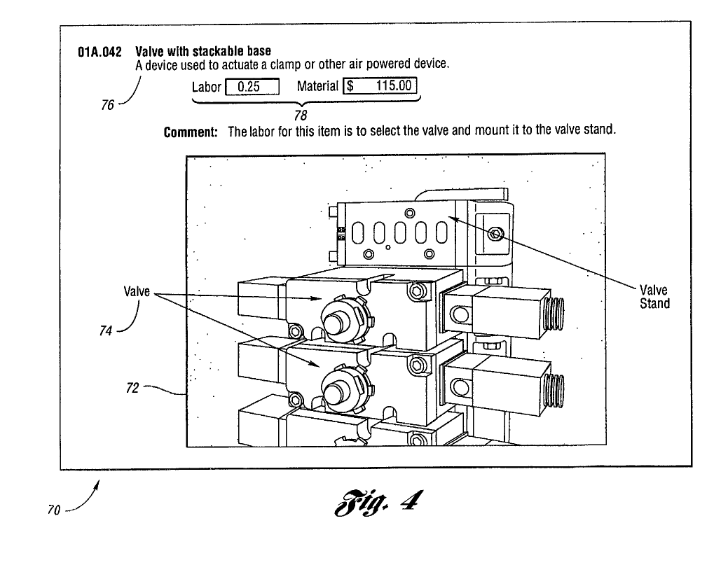

Upon selecting a detailed description button associated with a particular tool item component (e.g., Blade), the user is presented with the GUI 70, illustrated in FIG. 4.

Referring now to FIG. 4, each detailed description preferably includes at least one true-to-life photograph 72 of the component or subassembly, annotations 74, a general description 76 of the component and its purpose, and a detailed material and labor assessment 78.

Referring again to FIG. 3, cost information provided for the tool item supply chain preferably includes:Total Build Labor Hours, Subtotal Build Hours, Cut & Weld Hours, Large Machine Hours, Small Machine Hours, Other Misc. Service Hours, Unit Assembly, Material Cost, Subtotal Material Cost, Purchased Material Cost, Raw Material Cost, Piping Labor Hours, Subtotal Piping Labor, Piping Material, Subtotal Piping Material, Wiring Labor Hours, Wiring Labor Subtotal, Wiring Material Cost, Wiring Material Subtotal, Tryout & Integration, Mechanical Design Hours, Controls Design Hours, Diagnostic Hours, Pipe And Wire Design Hours, Hardware Design Hours, Logic Design Hours, Mechanical Design Hours, Controls Design Hours, Diagnostic Hours, Pipe And Wire Design Hours, Hardware Design Hours, Logic Design Hours.

Notably, a hyperlink 64 is provided for each supply chain component having a nested supply chain (i.e., a supply chain of its own). By selecting a tool item supply chain component hyperlink 64, the user is presented with a nested GUI similar to that illustrated in FIG. 3.

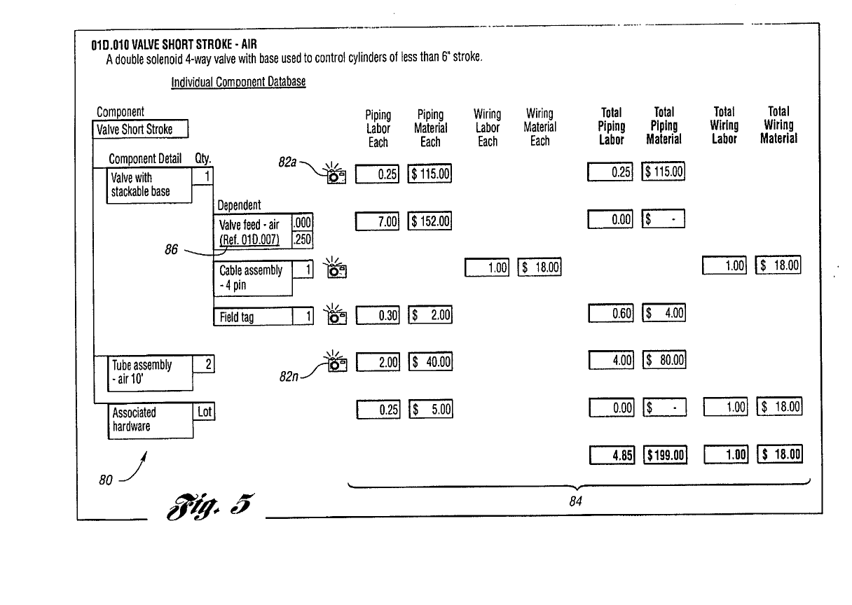

Referring now to FIG. 5, a nested component supply chain 80 including associated description/photograph buttons 82a −82n material, design, and labor costs 84 is shown. Similar to the tool item supply chain illustrated in FIG. 3, a hyperlink 86 is provided for each component supply chain item having a nested supply chain of its own. Accordingly, a significant advantage of the present invention is the user's ability to “drill down” to the lowest level of each nested supply chain associated with the current program cost estimate 10 illustrated in FIG. 1. It is an additional advantage of the present invention that at each supply chain level, the user has the ability to view detailed cost information, pictures and detailed descriptions of each assembly and supply chain item.

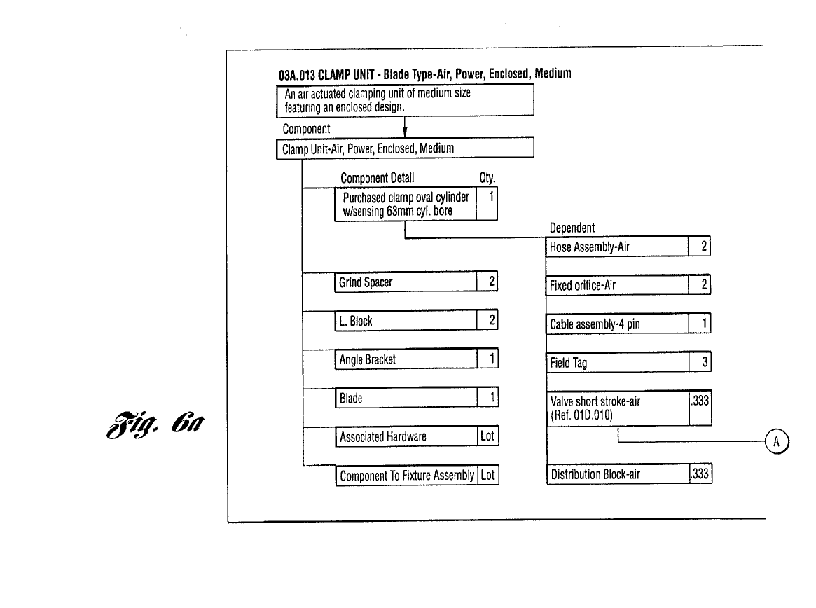

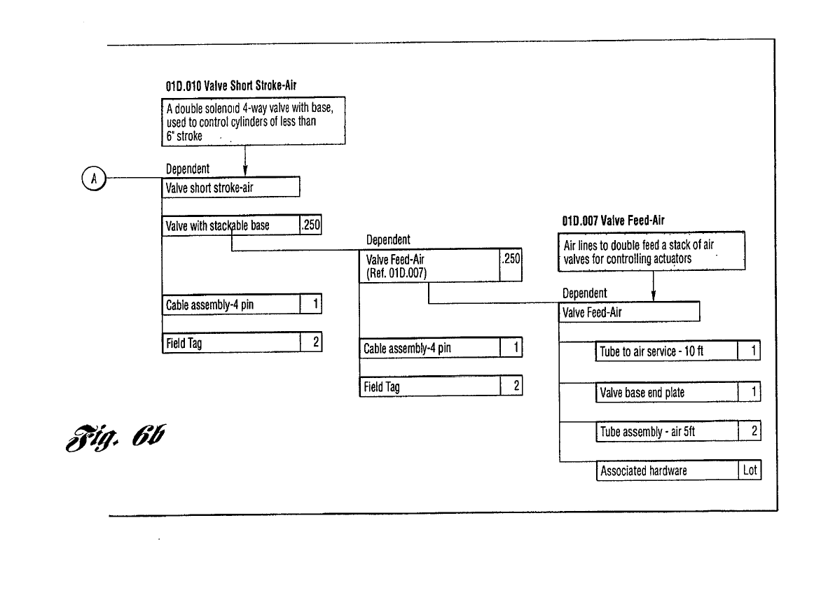

Referring again to FIG. 3, a hyperlink 66 is provided for allowing a user to view a dependency tree (i.e., supply chain without associated cost information). FIGS. 6a and 6b, in combination, illustrates an example dependency tree for the clamp unit tool item described in FIG. 3.

Referring again to FIG. 3, hyperlink 68 enables a user to view a design estimate for the tool item. FIG. 7 contains an example design estimate for the clamp tool item. Generally, the design estimate comprises a detailed breakdown 90 of design hours associated with a particular assembly, subassembly or component of a tool, item or assembly. Additionally, a data field 92 receives and presents any additional information (i.e., “Notes”) that may be relevant to the design estimate.

Referring again to FIGS. 2a and 2b, an “Add Unique Line” button 49 enables a user to add a tool item to the tool item table 40 that is not presented in tool item drop-down menu 42. Unlike items selected from the drop-down menu 42, unique items added to the tool item table 40 will not be presented with predefined cost values. Accordingly, a user adding a unique item inputs any relevant description, quantity, cost information etc. Preferably, any unique items added to the item table 40 are highlighted to reflect that these items were user specified.

Another aspect of the tool estimate illustrated in FIGS. 2a and 2b includes a detailed estimate 47 of the cost of controls required for the tool estimate 40. Common tool controls may include electronic and pneumatic valves, junction boxes input/output boxes programmable logic controllers (PLCs), etc. In accord with a preferred embodiment of the present invention, the detailed control cost estimate 47 is generated automatically as the user selects and/or inputs tool items into the tool item table 40, based on the control systems and components selected tool items require. For example, adding the tool items necessary for constructing a geo station, as shown in FIGS. 2a and 2b, requires one valve feed, tow junction boxes, three remote input/output boxes and a zone control PLC 5/60 2-door panel.

Referring again to FIG. 1, a field 28 is provided for each tool item 34 which allows a user to indicate whether an added tool is a new tool or an alteration of an existing tool. In accord with a preferred embodiment of the present invention, the selection of “Alter” for a particular tool yields an adjusted tool cost 35 based on the savings and costs associated with retrofitting an existing tool to the new tool specifications.

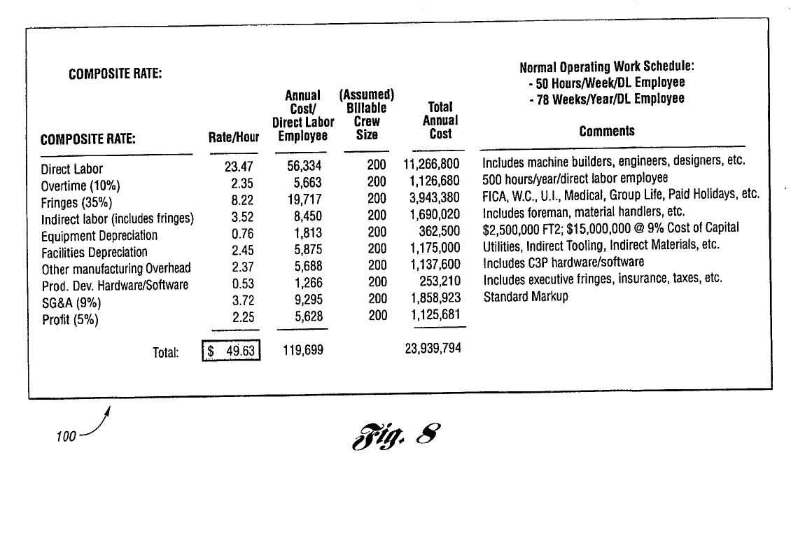

FIG. 8 illustrates an example GUI for defining a labor rate structure for use in generating cost estimates in accord with the present invention. To access the labor rate structure 100 in accord with a preferred embodiment of the present invention, a user selects hyperlink 22, illustrated in FIG. 1. Labor rate structure 100 comprises a variety of figures including, but not limited to, direct labor, overtime, fringe costs, indirect labor, equipment depreciation, facilities depreciation, other manufacturing overhead, product development hardware and software, selling, general and administrative costs (SG&A), and profit. Notably, each cost or rate contributing to the overall labor rate structure may be modified by the user. Preferably, labor rates included within the labor rate structure are defined based on an average or regional benchmark of competitive labor rates.

Database and M&TPI

In accord with a preferred embodiment of the present invention, a cost database maintains the information necessary for populating estimates generated in accord with the present invention. Information included in the cost database includes, but is not limited to, pricing and burden information, descriptions, assemblies, components, materials, tooling and controls, true-to-life materials, labor rates, user fees (water, electricity, sewer, etc.), item numbers and tax rates including excise taxes.

Preferably, pricing and burden information for each assembly, component, material, tool and control is maintained in a variety of user-selectable formats including “off-the-shelf” pricing, previously negotiated prices and best-in-class (BIC) pricing.

In further accord with the preferred embodiment, pricing information maintained within the cost database is globally updated based on a materials and tooling price index (M&TPI). The M&TPI represents periodic fluctuations in the burdens associated with the goods and services included within the cost database. As an economic indicator, the M&TPI provides a baseline to measure the effects of inflation, labor trends and costs of tooling. User fees (such as water and sewer service) and sales/excise taxes paid by the manufacturer are also included.

Prices for the goods and services used to calculate the M&TPI are collected from various suppliers as well as inquiries and audits of expenses from first-tier supply chain members. Additionally, the cost of raw materials, purchased goods and outside services are surveyed across the manufacturing, wholesale and supply base to the first-tier suppliers themselves. Preferably, the M&TPI is updated at least annually to provide an accurate reflection of the current cost of goods and services.

The M&TPI is calculated based on actual periodic price fluctuations experienced by a “basket of goods”—a small selection of items, the price of which reflect price fluctuations in the goods and services contained within the cost database. Items included within the basket of goods may include purchased goods (e.g., regulators, lubricators, transformers, relays etc.), raw materials (e.g., 1018 steel, etc.), and outside services (e.g., normalizing, case hardening, heat treating, etc.).

Printing Estimates

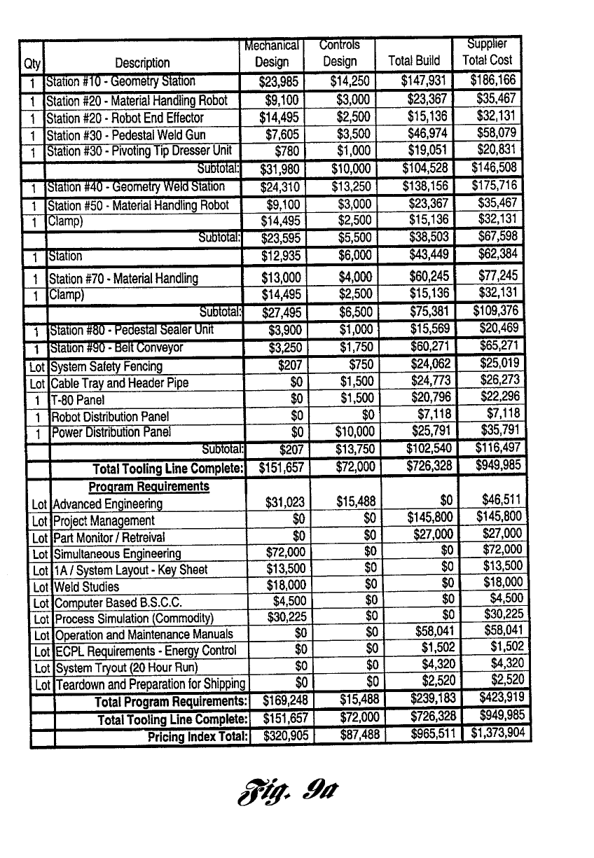

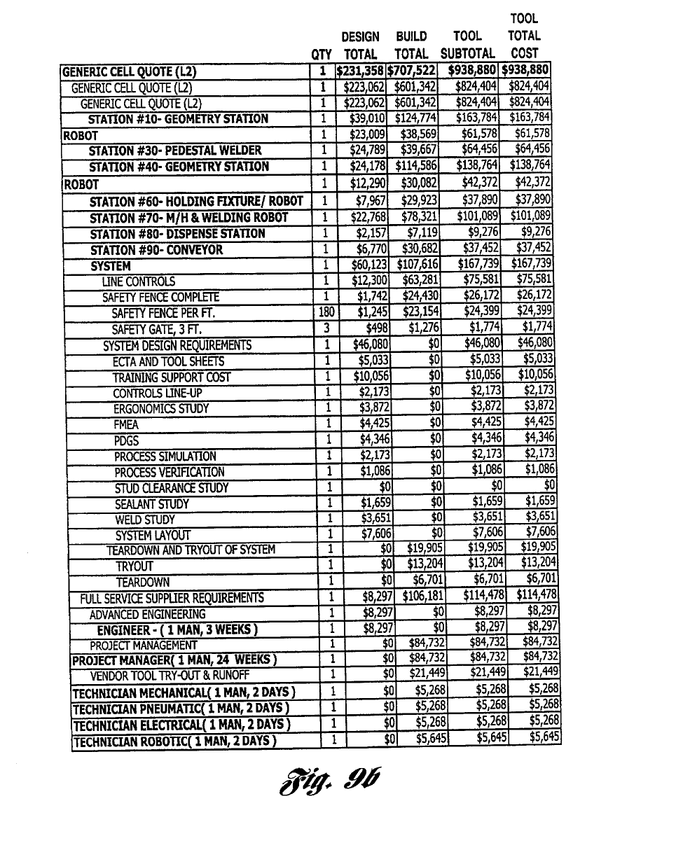

In accord with a preferred embodiment of the present invention, estimates are printed or otherwise output in a variety of formats matching or resembling the different cost estimate formats preferred by suppliers. FIGS. 9a and 9b comparatively illustrate two cost estimates having identical content that are generated in accord with the present invention. Notably, the format of the estimate illustrated in FIG. 9a, for hypothetical Supplier A, matches Supplier A's preferred estimate format and is substantially different than the estimate format generated for and preferred by hypothetical Supplier B as illustrated in FIG. 9b.

To print an estimate generated in accord with the present invention, the user selects the Print-“Supplier Format” button 25 illustrated in FIG. 1. In accord with a preferred embodiment of the present invention, the cost-estimating application may be configured in such a manner as to output (i.e., print) the current cost estimate 10 in a format matching the cost estimate format preferred by the supplier selected in drop-down menu 12.

Computer System

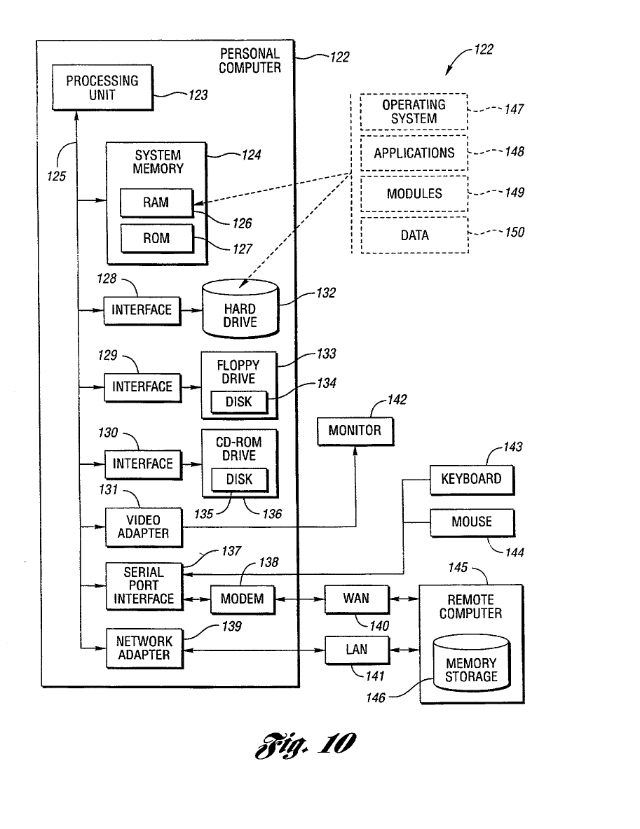

FIG. 10 illustrates a preferred computer system 120 for implementing the present invention. The computer system 120 comprises a server or personal computer 122 including a processing unit 123, a system memory 124 and a system bus 125 that interconnects various system components including the system memory 124 to the processing unit 123. The system bus 125 may comprise any of several types of bus structures including a memory bus or memory controller, a peripheral bus, and a local bus using a bus architecture such as PCI, VESA, Microchannel (MCA), ISA and EISA, to name a few. The system memory includes read only memory (ROM) 127 and random access memory (RAM) 126. A basic input/output system (BIOS), containing the basic routines that help to transfer information between elements within the computer 122, such as during startup, is stored in ROM 127. The computer 122 further includes a hard disk drive 132, a magnetic disk drive (floppy drive 133) to read from or write to a removable disk 134, and an optical disk drive (CD-ROM Drive 136) for reading a CD-ROM disk 135 or to read from or write to other optical media. The hard disk drive 132, magnetic disk drive 133, and optical disk drive 136 are connected to the system bus 125 by a hard disk drive interface 128, a magnetic disk drive interface 129 and an optical drive interface 130, respectively. The drives and their associated computer-readable media provide nonvolatile storage of data, data structures, computer-executable instructions (program code such as dynamic link libraries, and executable files), etc., for the computer 122. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like.

A number of program modules may be stored in the drives and RAM 126, including an operating system 147, one or more application programs 148, other program modules 149, and program data 150. A user may enter commands and information into the computer 122 through a keyboard 143 and pointing device, such as a mouse 144. Other input devices (not shown) may include a microphone, dictaphone, scanner, or the like. These and other input devices are often connected to the processing unit 123 through a serial port interface 137 that is coupled to the system bus, but may be connected by other interfaces, such as a parallel port, game port or a universal serial bus (USB). A monitor 142 or other type of display device is also connected to the system bus 125 via an interface, such as a video adapter 131. In addition to the monitor, the computer may include other peripheral output devices (not shown), such as speakers and a printer.

In a networked configuration, there is at least one client computer 145 having a similar architecture to computer 122 and configured to operate as a client to computer 122 which is, in the network embodiment, configured to operate as a server. The logical connections depicted in FIG. 10 between server computer 122 and client computer 145 include (but are not limited to) a local area network (LAN) 141 and a wide area network (WAN) 140. Such networking environments are commonplace in offices, enterprise-wide computer networks, intranets and the Internet.

When used in a LAN networking environment, the server computer 122 is connected to the local network 141 through a network interface or adapter 139. When used in a WAN networking environment, the server computer 122 typically includes a modem 138 or other means for establishing communications over the wide area network 140, such as the Internet. The modem 138, which may be internal or external, is connected to the system bus 18 via the serial port interface 125. In a networked environment, program modules depicted relative to the server computer 122, or portions of them, may be stored in a remote memory storage device (not shown).

Negotiation Method

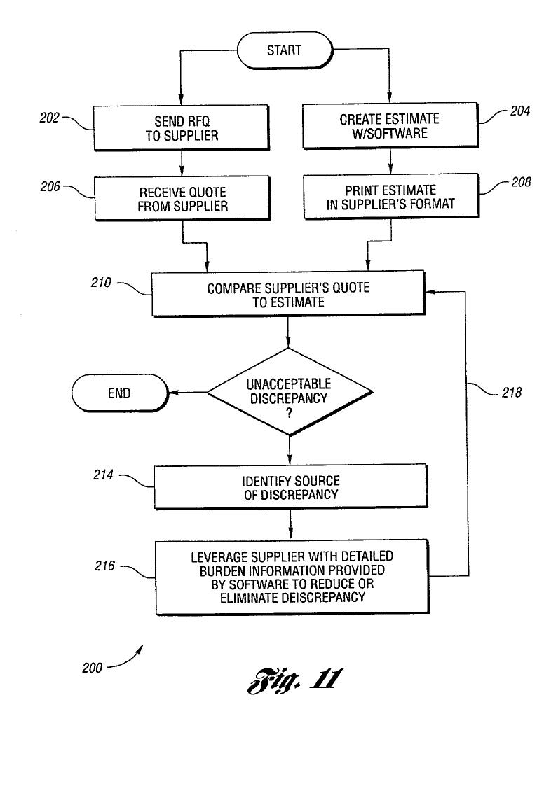

FIG. 11 is a block flow diagram illustrating a preferred buyer-supplier negotiation method 260 in accord with the present invention. Notably, the flow and/or steps associated with a buyer-seller negotiation may be rearranged or modified to best suit the particular circumstances of that negotiation within the scope of the present invention.

As represented in block 202, the buyer (e.g., manufacturer) sends a request for quote (RFQ) for manufacturing tooling/equipment to a supplier. Upon receipt, the supplier responds to the RFQ and sends the complete quote back to the buyer for consideration, as represented in block 206. As represented in block 204, the buyer creates an estimate for the quoted manufacturing tooling/equipment with the cost-estimating software application provided in accord with the present invention. The buyer next prints the estimate in a format similar to the supplier's, as represented in block 208. Printing the cost estimate in the supplier's quote format facilitates the comparison of the supplier's quote and the buyer's estimate generated in accord with the present invention.

As represented in block 210, the buyer compares the supplier's quote and the buyer's estimate generated in accord with the present invention to identify any unacceptable discrepancies. Potential discrepancies include, but are not limited to, component/assembly design cost, manufacturing cost, labor rates, design and manufacturing times, and material costs.

Upon identifying an unacceptable discrepancy between the supplier's quote and the buyer's estimate, the source of the discrepancy is identified, as represented in block 214. Preferably, the source of the discrepancy is identified with the assistance of the cost-estimating software illustrated and described with respect to FIGS. 1 through 9. Utilizing the software, a negotiator can easily review the source of cost totals including detailed descriptions and breakdowns of the relevant design times, component costs, manufacturing time, labor rates, etc. In addition, the negotiator can “drill down” into the supply chain for the quoted tooling to identify and explain any nested costs. Accordingly, it is an objective of the present invention to provide a negotiator representing either a buyer or a seller with a user-friendly tool for accurately defining the composition of and costs associated with manufacturing tooling. As a result of this advantage, negotiators may rely upon quantitative content-based foundations for their estimates, thereby reducing the likelihood or effect of intimidation caused by a negotiator's lack of experience during negotiations.

As represented in block 216, the buyer negotiates with the supplier to eliminate the identified discrepancy, or at least reduce it to an acceptable level. To do so, the buyer preferably utilizes the cost-estimating software illustrated in FIGS. 1 through 9 to show the supplier's negotiator the detailed foundation for the buyer's cost estimate (i.e., detailed cost breakdown, labor structure, pictures, etc.). As represented by arrow 218, the steps of identifying and eliminating/reducing discrepancies is repeated until all discrepancies between the buyer's estimate and supplier's quote are eliminated or are at an acceptable level.

While the best mode for carrying out the invention has been described in detail, those familiar with the art to which this invention relates will recognize various alternative designs and embodiments for practicing the invention as defined by the following claims.

1. A system for generating a cost estimate, the system configured to:
receive input specifying at least one item to add to a cost estimate wherein a burden associated with the at least one item is automatically added to the cost estimate; and
output a first value chain for the at least one item by the item's constituent component(s) and supply tier wherein the value chain includes an image and burden information for the at least one item and each of its constituent components.

2. The system of claim 1 additionally configured to output an embedded value chain associated with an item displayed in the first value chain wherein the embedded value chain is illustrated by supplier tier and includes an image and burden information for at least one item within the embedded value chain.

3. The system of claim 1 additionally configured to expand and decrease a level of detail for the burden information associated with the at least one item.

4. The system of claim 1 wherein the burden information associated with the at least one item includes design cost information.

5. The system of claim 1 wherein the burden information associated with the at least one item includes controls cost information.

6. The system of claim 1 additionally configured to receive input defining a labor rate structure used in calculating burden information for the cost estimate.

7. The system of claim 1 additionally configured to output the cost estimate in a format similar to a supplier's cost estimate format.

8. The system of claim 1 wherein the cost burdens associated with the items included in the cost estimate and value chain are populated based on a database of cost burdens.

9. The system of claim 8 wherein the cost burdens maintained within the database are globally updated based on an index value which reflects fluctuations in market pricing for items included in the database.

10. The system of claim 9 wherein the index is calculated based on price fluctuations experienced in a subset of items generally representative of other items maintained in the database.

11. The system of claim 8 wherein the database of cost burdens include negotiated, best-in-class and off-the-shelf costs for at least one item.

12. A computer-implemented method for generating a cost estimate, the method comprising:
receiving input specifying at least one item to add to a cost estimate wherein a burden associated with the at least one item is automatically added to the cost estimate; and
outputting a first value chain for the at least one item by the item's constituent component(s) and corresponding supply tier wherein the value chain includes an image and burden information for the at least one item and each of its constituent components.

13. The method of claim 12 further comprising outputting an embedded value chain associated with an item displayed in the first value chain wherein the embedded value chain is illustrated by supplier tier and includes an image and burden information for at least one item within the embedded value chain.

14. The method of claim 12 further comprising expanding and decreasing a level of detail for the burden information associated with the at least one item.

15. The method of claim 12 additionally comprising globally adjusting the burden information based on an index value which reflects fluctuations in market pricing for the at least one item.

16. The method of claim 12 further comprising outputting the cost estimate in a format similar to a supplier's cost estimate format.

17. A method for negotiating a price for manufacturing tooling, the method comprising:
receiving a quote for a manufacturing tool from a manufacturing tool supplier;
generating an estimate for the manufacturing tool wherein the estimate is generated electronically independent of the quote and in a format similar to the format of the quote;
comparing the quote and the estimate to identify at least one unacceptable discrepancy in pricing; and
during negotiation with the supplier, leveraging the supplier with a plurality of cost burden and value chain information corresponding to the manufacturing tool to reduce the at least one discrepancy in pricing wherein the plurality of cost burden and value chain information is provided electronically based on the cost estimate.

18. The method of claim 17 wherein the estimate is generated electronically by a cost-estimating software application configured to present detailed burden information, a value chain and a plurality of images corresponding to the manufacturing tool.

19. A system for generating a cost estimate, the system comprising:
a means for specifying at least one item to add to a cost estimate wherein a burden associated with the at least one item is automatically added to the cost estimate; and
a means for outputting a value chain for the at least one item by the item's constituent component(s) and corresponding supply tier wherein the value chain includes an image and burden information for the at least one item and each of its constituent component(s).

20. The system of claim 19 additionally comprising a means for outputting the cost estimate in a format similar to a supplier's cost estimate format.

21. The system of claim 19 additionally comprising a means for reducing and expanding a scope for the value chain.

22. The system of claim 19 additionally comprising:
a means for outputting a plurality of burdens associated with the at least one item; and
a means for expanding and reducing a level of detail in which the plurality of burdens are output.

23. The system of claim 22 additionally comprising a means for globally adjusting the value of the plurality of cost burdens based on an index value which reflects fluctuations in market pricing.
